(19) United States
(12) Patent Application Publication
(10) Pub. No.: US 2009/0185392 A1
(43) Pub. Date: Jul. 23, 2009

(54) DETACHABLE ILLUMINATION SYSTEM

(75) Inventors: Robert J. Krupa, Leominster, MA (US); Thomas V. Root, Beverly, MA (US)

Correspondence Address: PROSKAUER ROSE LLP, ONE INTERNATIONAL PLACE, BOSTON, MA, 02110, US

(73) Assignee: Optim, Inc., Sturbridge, MA (US)

(21) Appl. No.: 12/360,036

(22) Filed: Jan. 26, 2009

Related U.S. Application Data
(63) Continuation-in-part of application No. 11/323,481, filed on Dec. 30, 2005.
Application No. 11/323,481 is a continuation-in-part of application No. 10/810,504, filed on Mar. 26, 2004, now Pat. No. 7,229,201.
(60) Provisional application No. 60/457,672, filed on Mar. 26, 2003.

(51) Int. Cl. H01S 3/00; G02B 6/02; H01J 1/62

(52) U.S. Cl. 362/553; 362/551; 362/574

(57) ABSTRACT

Illumination devices utilized within detachable illumination systems include a light source including a substantially planar light-emitting surface and an optical rod or optical taper disposed proximate to the substantially planar light-emitting surface to optically couple the optical rod and the substantially planar light-emitting surface.

### RELATED APPLICATIONS

This application is a continuation-in-part of U.S. patent application Ser. No. 11/323,481, which is a continuation-in-part of U.S. patent application Ser. No. 10/810,504 filed on Mar. 26, 2004, and issued as U.S. Pat. No. 7,229,201. U.S. patent application Ser. No. 10/810,504 claims the benefit of U.S. Provisional Application No. 60/457,672, filed on Mar. 26, 2003. The disclosures of each of the applications identified above are incorporated herein in their entirety by reference.

### FIELD OF THE INVENTION

This invention relates to a detachable illumination system including an illumination device comprising a substantially planar light-emitting surface coupled to an optical rod or optical taper.

### BACKGROUND OF THE INVENTION

Advances in light source technology, such as, for example, light-emitting diode (LED) technology, have led to very bright and reliable solid state lamps. However, challenges remain with respect to coupling LEDs to optical transmission media, such as, for example, optical rods and optical tapers. While there have been numerous attempts to utilize low power (<1 W electrical power consumption, typically operating below 100 mW) light-emitting diodes (LEDs) coupled to fiber optic light guides or other optical devices as light sources for endoscopy, dentistry, and for remote illumination of objects (as with a flashlight, head light, or lamp), most of these prior attempts have employed numerous low power LEDs for remote illumination. Generally, multiple LEDs are necessary because the light output from a single, low power LED is typically too weak to properly illuminate an object. In addition, the arrangement of the multiple LEDs to the optical transmission media used in these prior attempts has resulted in unacceptable light loss, thereby further decreasing the low power LED's ability to properly illuminate an object.

### SUMMARY OF THE INVENTION

In general, the present invention relates to increasing the amount of light transmitted through an illumination device by means of an inventive coupling approach between a light source and an optical rod or optical taper (i.e., an optical coupling device having substantially flat input and output ends). In some embodiments, the invention further relates to an endoscope (e.g., medical or industrial) including the inventive coupling approach, a lamp (e.g., a table top light source, a flashlight) including the inventive coupling approach, or a head light including the inventive coupling approach. Certain embodiments of the present invention, utilize a high power LED, (i.e., an LED having a power consumption of 1 or more Watts (e.g., 5 W, 10 W, 50 W, 75 W, 100 W)).

In one aspect, the invention relates to a detachable illumination system. The detachable illumination system includes a housing that detachably connects to a light receiving member. The detachable illumination system also includes an illumination device disposed within a recess in the housing, the illumination device including a substantially planar light-emitting surface. The detachable illumination system also includes an optical rod or taper including an input end that is proximate to the substantially planar light-emitting surface and an output end that is proximate to the light receiving member.

Embodiments of this aspect of the invention can include one or more of the following features. The optical taper can provide a light exit angle that substantially matches an acceptance angle of the light receiving member. The housing can include a mechanical connector so that the housing can be detachably connected to the light receiving member. The illumination device can include a solid state light source, such as, for example, a light-emitting diode including one or more light emitting chips, or a laser, such as a vertical-cavity surface emitting laser.

In other embodiments, the substantially planar light-emitting surface includes a flat transparent plate disposed above the light-emitting diode. The substantially planar light-emitting surface can include an emitting surface of the light-emitting diode, the system further including a substance disposed between the emitting surface and the input end of the optical rod or taper that emits light when the light-emitting diode is activated. The substance can include at least one of a phosphor or a fluorophor. The substance can be a solid material including at least one of a phosphor or a fluorophor.

In some embodiments, the detachable illumination system includes an adhesive disposed between the substantially planar light-emitting surface and the input end of the optical rod or taper. The detachable illumination system can include an index matching material disposed between the substantially planar light-emitting surface and the input end of the optical rod or taper. The light receiving member can be disposed within an endoscope. The housing including the illumination device can be disposed within a table top device.

In other embodiments, the optical rod or taper includes a cross sectional shape that substantially matches a shape defined by a perimeter of the substantially planar light-emitting surface. A cross sectional area of the input end of the optical rod or taper can match a cross sectional area of the substantially planar light-emitting surface. Alternatively, the cross sectional shape can differ so long as the cross sectional areas of the light emitting surface of the solid state light source and the input end of the rod or taper are substantially approximate to each other. The optical rod or taper can include a round cross section. The optical rod or taper can include a polygonal cross section. The polygonal cross section can include a square cross section or a hexagonal cross section. The input end of the optical rod or taper can include a first geometric cross section and the output end of the optical rod or taper can include a second geometric cross section. The first geometric cross section can have a shape that differs from the second geometric cross section. For example, the first geometric cross section can be a square cross section and the second geometric cross section can be a round cross section. In another example, the first geometric cross section can be a round cross section and the second geometric cross section can be a square cross section. The detachable illumination system can include a reflective coating on the outside of the optical rod or taper. The reflective coating can be an aluminum coating or a silver coating. In another example, the optical rod or taper can be a hollow optical rod or taper. The hollow optical rod or taper can include a reflective coating inside the hollow optical rod or taper. In another example, the optical rod or taper can be an optically clad rod or taper.

In one aspect, the invention relates to a detachable illumination system. The detachable illumination system includes a housing that detachably connects to a light receiving member including an optical rod or taper and a light guide, wherein the optical rod or taper is positioned on a light input end of the light receiving member. The detachable illumination system includes an illumination device disposed within a recess in the housing, the illumination device including a substantially planar light-emitting surface that is proximate to the light input end of the light receiving member, the illumination device comprising a solid state light source and at least one of an optical rod or taper.

Embodiments of this aspect of the invention can include one or more of the following features. The optical taper can provide a light exit angle that substantially matches an acceptance angle of a light guide. The housing can include a mechanical connector so that the housing can be detachably connected to the light receiving member. The illumination device can include a solid state light source, such as, for example, a light-emitting diode including one or more light-emitting chips, or a laser, such as a vertical-cavity surface emitting laser.

In other embodiments, the substantially planar light-emitting surface includes a flat transparent plate disposed above the light-emitting diode. The substantially planar light-emitting surface can include an emitting surface of the light-emitting diode, the system further including a substance disposed between the emitting surface and the light input end of the light receiving member that emits light when the light-emitting diode is activated. The substance can include at least one of a phosphor or a fluorophor. The substance can be a solid material including at least one of a phosphor or a fluorophor.

In some embodiments, the detachable illumination system includes an adhesive disposed between the substantially planar light-emitting surface and the light input end of the light receiving member. The detachable illumination system can include an index matching material disposed between the substantially planar light-emitting surface and the light input end of the light receiving member. The light receiving member can be disposed within an endoscope. The housing including the illumination device can be disposed within a table top device.

In other embodiments, the optical rod or taper includes a cross sectional shape that substantially matches a shape defined by a perimeter of the substantially planar light-emitting surface. A cross sectional area of an input end of the optical rod or taper can match a cross sectional area of the substantially planar light-emitting surface. Alternatively, the cross sectional shape can differ so long as the cross sectional areas of the light emitting surface of the solid state light source and the input end of the rod or taper are substantially approximate to each other. The optical rod or taper can include a round cross section. The optical rod or taper can include a polygonal cross section. The polygonal cross section can include a square cross section or a hexagonal cross section. An input end of the optical rod or taper can include a first geometric cross section and an output end of the optical rod or taper can include a second geometric cross section. The first geometric cross section can have a shape that differs from the second geometric cross section. For example, the first geometric cross section can be a square cross section and the second geometric cross section can be a round cross section. In another example, the first geometric cross section can be a round cross section and the second geometric cross section can be a square cross section. The detachable illumination system can include a reflective coating on the outside of the optical rod or taper. The reflective coating can be an aluminum coating or a silver coating. In another example, the optical rod or taper can be a hollow optical rod or taper. The hollow optical rod or taper can include a reflective coating inside the hollow optical rod or taper. In another example, the optical rod or taper can be an optically clad rod or taper.

In one aspect, the invention relates to a detachable illumination system. The detachable illumination system includes a housing that detachably connects to a light receiving member, the housing comprising an illumination device, the illumination device including a substantially planar light-emitting surface. The detachable illumination system also includes an optical rod or taper comprising an input end that is proximate to the substantially planar light-emitting surface and an output end that is proximate to the light receiving member.

Embodiments of this aspect of the invention can include one or more of the following features. The optical taper can provide a light exit angle that substantially matches an acceptance angle of the light receiving member. The housing can include a mechanical connector so that the housing can be detachably connected to the light receiving member. The illumination device can include a solid state light source, such as, for example, a light-emitting diode including one or more light emitting chips, or a laser, such as a vertical-cavity surface emitting laser.

In other embodiments, the substantially planar light-emitting surface includes a flat transparent plate disposed above the light-emitting diode. The substantially planar light-emitting surface can include an emitting surface of the light-emitting diode, the system further including a substance disposed between the emitting surface and the input end of the optical rod or taper that emits light when the light-emitting diode is activated. The substance can include at least one of a phosphor or a fluorophor. The substance can be a solid material including at least one of a phosphor or a fluorophor.

In some embodiments, the detachable illumination system includes an adhesive disposed between the substantially planar light-emitting surface and the input end of the optical rod or taper. The detachable illumination system can include an index matching material disposed between the substantially planar light-emitting surface and the input end of the optical rod or taper. The light receiving member can be disposed within an endoscope. The housing including the illumination device can be disposed within a table top device.

In other embodiments, the optical rod or taper includes a cross sectional shape that substantially matches a shape defined by a perimeter of the substantially planar light-emitting surface. A cross sectional area of the input end of the optical rod or taper can match a cross sectional area of the substantially planar light-emitting surface. Alternatively, the cross sectional shape can differ so long as the cross sectional areas of the light emitting surface of the solid state light source and the input end of the rod or taper are substantially approximate to each other. The optical rod or taper can include a round cross section. The optical rod or taper can include a polygonal cross section. The polygonal cross section can include a square cross section or a hexagonal cross section. The input end of the optical rod or taper can include a first geometric cross section and the output end of the optical rod or taper can include a second geometric cross section. The first geometric cross section can have a shape that differs from the second geometric cross section. For example, the first geometric cross section can be a square cross section and the second geometric cross section can be a round cross section. In another example, the first geometric cross section can be a round cross section and the second geometric cross section can be a square cross section. The detachable illumination system can include a reflective coating on the outside of the optical rod or taper. The reflective coating can be an aluminum coating or a silver coating. In another example, the optical rod or taper can be a hollow optical rod or taper. The hollow optical rod or taper can include a reflective coating inside the hollow optical rod or taper. In another example, the optical rod or taper can be an optically clad rod or taper.

In one aspect, the invention relates to a detachable illumination system. The system includes a housing that detachably connects to a light receiving member and includes an illumination device. The illumination device of the system includes a solid state light source having a substantially planar light-emitting surface and an optical coupling device comprising a substantially flat input end that is proximate to the substantially planar light-emitting surface of the solid state light source and a substantially flat output end that is proximate to the light receiving member.

Any of the above implementations can realize one or more of the following advantages. The illumination devices, systems and methods described above are efficient at transmitting light from the light source into the optical rod or optical taper. As a result, objects can be illuminated with a proper amount of light (e.g., object is visible under endoscopic examination, object under a lamp is sufficiently lighted for viewing purposes). Another advantage realized in the above embodiments is that the optical rod or optical taper can be coupled to the light source without the use of additional optical components or auxiliary optics, such as, for example, mirrors, lenses, reflectors. As a result, a large amount of the light emitted by the light source can be coupled directly into the optical rod or optical taper, thereby allowing a greater amount of light from the light source to be transmitted to the objects under investigation. The lack of auxiliary optics between the light source and the optical rod or taper also simplifies the mechanical design and size of the illumination device. In addition, the high light output and high coupling efficiency of the light emitted by the light source into the optical rod or optical taper increases battery lifetime and thus permits the use of smaller capacity, and smaller volume batteries to power the illumination device.

### BRIEF DESCRIPTION OF THE DRAWINGS

The foregoing and other features and advantages of the present invention, as well as the invention itself, will be more fully understood from the following description of various embodiments, when read together with the accompanying drawings.

FIG. 1 is an illustration of a prior art illumination device including a LED-based light source.

FIG. 2 is an illustration of an illumination device including a substantially planar light-emitting surface in accordance with the present invention.

FIG. 3 is an illustration of another embodiment of an illumination device including a substantially planar light-emitting surface in accordance with the present invention.

FIG. 4 is an illustration of another embodiment of an illumination device including a substantially planar light-emitting surface in accordance with the present invention.

FIG. 5 is an illustration of another embodiment of an illumination device including a substantially planar light-emitting surface in accordance with the present invention.

FIG. 5A is an illustration of another embodiment of an illumination device including a substantially planar light-emitting surface in accordance with the present invention.

FIG. 5B is an illustration of another embodiment of an illumination device including a substantially planar light-emitting surface in accordance with the present invention.

FIG. 5C is a cross-sectional illustration of a portion of an illumination system in which the surface area of a light input end of a light receiving member approximates the surface area of a light emitting surface of the LED.

FIG. 5D is a cross-sectional illustration of a portion of an illumination system in which the surface area of the light input end of the light receiving member approximates the surface area of the light emitting surface of the LED.

FIG. 5E is a cross-sectional illustration of a portion of an illumination system in which the surface area of the light input end of the light receiving member approximates the surface area of the light emitting surface of the LED.

FIG. 5F is an illustration of another embodiment of an illumination device including a substantially planar light-emitting surface in accordance with the present invention

FIG. 6 is an illustration of another embodiment of an illumination device including a substantially planar light-emitting surface in accordance with the present invention.

FIG. 6A is an illustration of another embodiment of an illumination device including a substantially planar light-emitting surface in accordance with the present invention.

FIG. 6B is an illustration of another embodiment of an illumination device including a substantially planar light-emitting surface in accordance with the present invention.

FIG. 7 is an illustration of the illumination device of FIG. 6 disposed within a handle of an endoscope.

FIG. 8 is an illustration of another embodiment of an illumination device including a substantially planar light-emitting surface in accordance with the present invention.

### DETAILED DESCRIPTION

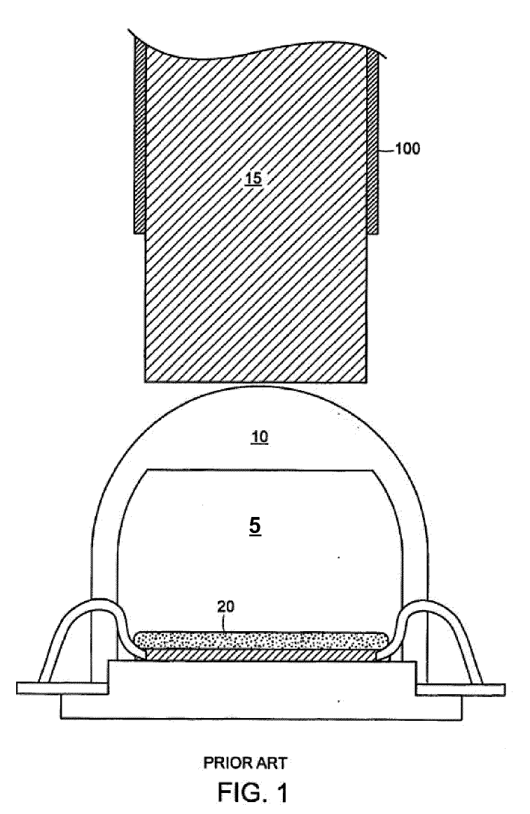

Prior art illumination devices, such as, for example, the illumination device shown in FIG. 1, include a light source 5 having a dome-shaped lens 10 optically coupled to transmission media 15. With this coupling arrangement, light is ineffectively transmitted to the transmission media 15 because the light emitting portion 20 of the light source 5 is not sufficiently close to the transmission media 15 (i.e., due to the curvature of the dome lens 10, the light emitting portion 20 is spaced at an unacceptable distance away from the transmission media). In addition, the dome shape lens 10 provides a convex light-emitting surface. As a result, a portion of the light passing through an interface between the light source 5 and the transmission media 15 is lost, thereby decreasing the light strength and efficiency of conventional illumination devices.

Illumination devices and detachable illumination systems including the illumination devices of the present invention include a substantially planar light-emitting surface which is proximate to either an optical rod or an optical taper. As a result, a greater amount of light is transmitted from the light source to the optical rod or taper than in prior art systems. Moreover, the optical rod or taper is a coupling device that provides two (e.g., input end, output end) substantially flat surfaces, which are efficient for light transmission.

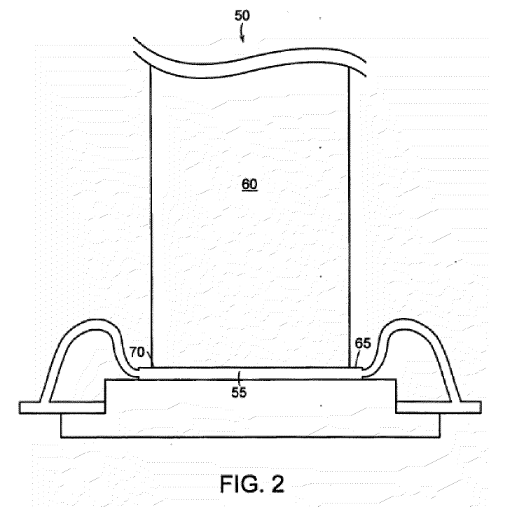

In accordance with one embodiment of the invention, an illumination device 50 shown in FIG. 2 includes a LED 55, such as, for example, a high power LED (Luxeon III Model LXHL-LW3C, Lumileds Lighting, San Jose, Calif.; Cree XLamp MC-E Model MCE4WT-A2-000-000M01, Cree, Inc., Durham, N.C.) and an optical rod 60. A dome lens, such as the dome lens 10 shown in FIG. 1, and any index matching material surrounding the LED 55 was not employed or was removed prior to coupling the LED 55 to the optical rod 60. As a result, the substantially planar light-emitting surface 65 of the LED 55 (e.g., the surface of a light-emitting chip in the LED 55) is proximate to a first end 70 of the optical rod 60. The substantially planar light-emitting surface 65 and the first end 70 together form a planar interface in which light can be transmitted with less light loss than in an interface including a curved or convex surface.

The coupling arrangement of the light source 55 and the optical rod 60 provides many advantages to the illumination device 50 over prior art systems. Besides an increase in the amount of light transmitted through the illumination device, the coupling arrangement shown in FIG. 2 provides light source protection and mechanical stability to the illumination device 50. Specifically, the optical rod 60 protects the LED 55 from the external environment and also provides an additional advantage of being a rugged element to which additional elements of the illumination device can be easily coupled to. For example, referring to FIG. 3, a light receiving member, such as a light guide bundle 80 formed of a plurality of optical fibers and held together by a ferrule 85 can easily be attached to the optical rod 60 without fear of damaging the light-emitting diode 55. The light receiving member 80 while described as a bundle of fibers with respect to FIG. 3 can also be formed of a single fiber, a rod, a taper, a post, or any combination thereof. For example, in some embodiments the light receiving member 80 can include a taper attached to a bundle of fibers.

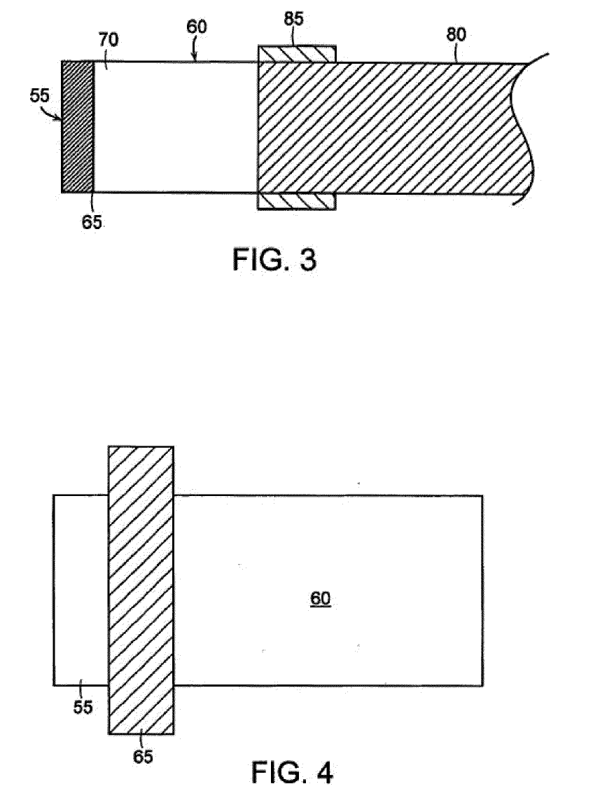

The substantially planar light-emitting surface 65 of the LED 55 is the top surface of the LED chip. In some embodiments, the substantially planar light-emitting surface 65 can further include a coating of a substance that emits white light or one or more specific colors of light when activated. For example, the substantially planar light-emitting surface 65, in certain embodiments, includes a solid phosphor and/or fluorophor (e.g., a ceramic plate), a film or coating on the top surface of the LED 55. In other embodiments, such as the embodiments shown in FIG. 4, the substantially planar light-emitting surface 65 can be formed of a transparent flat plate (e.g., a transparent window) placed over the LED 55. In this embodiment, light is emitted from the top surface of the LED 55 and then through the transparent window. The flat window is proximate to the optical rod 60 and forms a planar interface with the optical rod. In other embodiments, the substantially planar light emitting surface 65 is formed by a substantially flat package or flat encapsulant, such as the flat package design of the Microsemi UPX3LEDxx (Microsemi Corporation, 580 Pleasant Street, Watertown, Mass.) and the PhlatLight™ white LEDxx illumination products, such as CBT-90 or CBM-360 (Luminus Devices, Inc., 1100 Technology Park Drive, Billerica, Mass.).

Optical rod 60 can be formed from a transparent material or any material which allows light to pass through. Examples of materials that can be used to form the optical rod include glass, plastic, and sapphire. In addition, the optical rod can be a clad rod or a rod with an outer reflective coating, such as for example, a silvered rod or an aluminized rod. In some embodiments the rod is formed from a single unitary piece of material. In other embodiments, the rod is formed form a plurality of fibers (e.g., fiber bundle). The rod 60 can also be a hollow tube or structure (e.g., square, triangular, etc. cross-sectional shape) with a reflective coating on its interior surface.

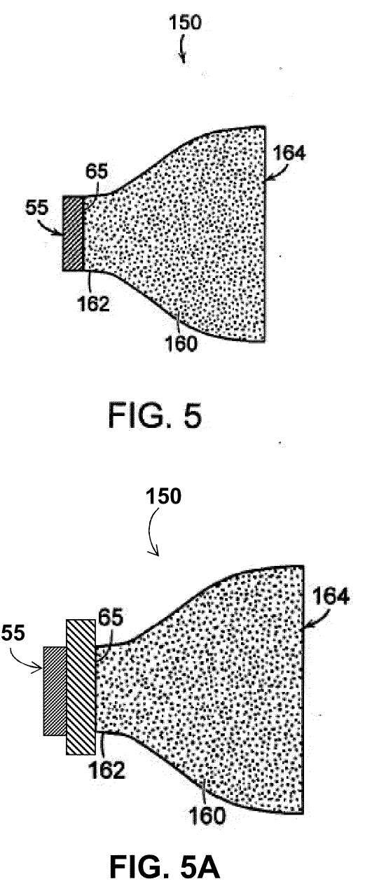

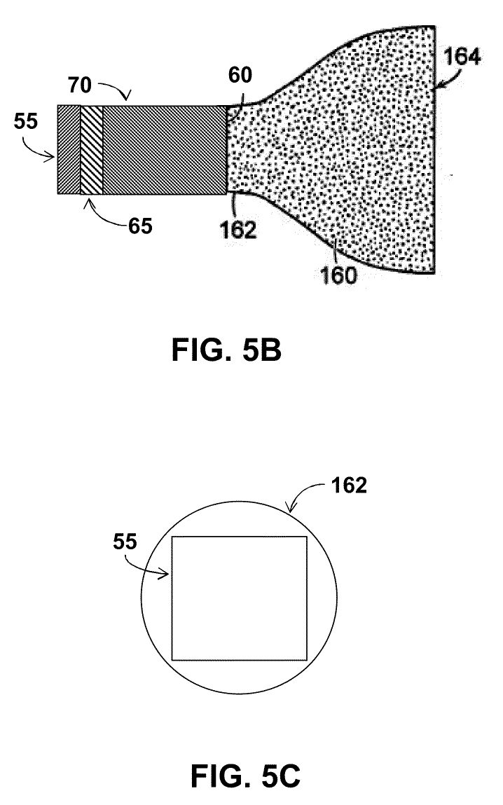

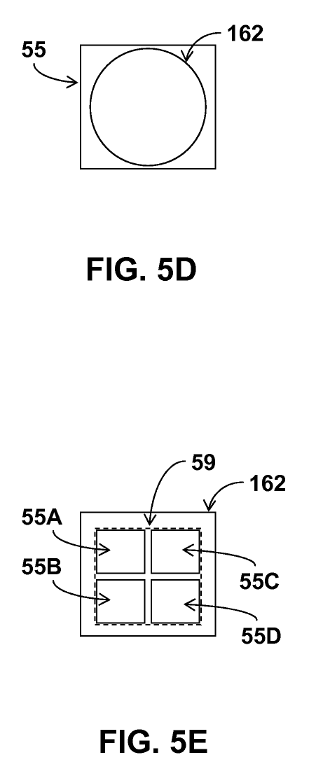

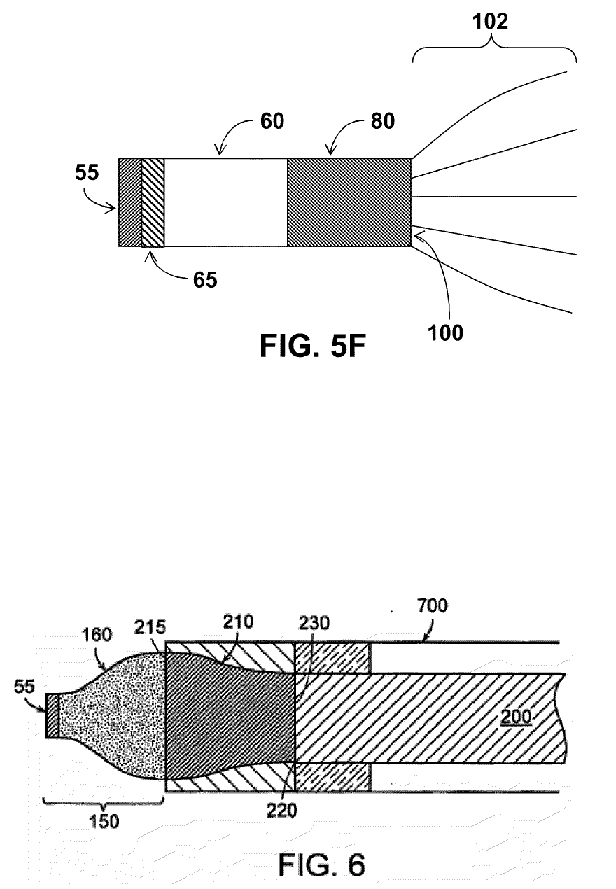

Referring to FIG. 5, illumination device 150 includes LED 55 and an optical taper 160 positioned proximate to the substantially planar light-emitting surface 65 of the LED 55. Optical taper 160 is formed from any transparent material such as, for example, glass or plastic, and has a first end or a smaller surface area end 162 and a second end or a larger surface area end 164. The optical taper 160 can be made from a solid rod of transparent material that is drawn down to a smaller diameter or profile at one end. In other embodiments, the optical taper can be formed from a plurality of fibers (e.g., a fiber taper) that are also drawn down in diameter or profile at the small surface area end 162. The optical taper 160 can include cladding or a reflective coating, such as an aluminum or silver coating, on its outer or exterior surface. In some embodiments, the taper 160 is formed of a hollow structure with a reflective coating on its interior surface.

The optical taper 160 provides the advantage of resizing and reshaping the output of the light from the light source (e.g., LED 55). For example, a typical LED die is about a 1 mm×1 mm square that emits light over a broad angular cone. Employing a high index of refraction transparent material, such as, for example glass or plastic, in the taper 160 produces a high acceptance angle of light at the first end or smaller surface area end 162 of the taper. The larger surface area end 164 of the taper exhibits a reduction in the numerical aperture (NA) by the ratio of the end diameters. For example, a 1:3 taper made from glass has an angular aperture at the first end 162 of 123 degrees and a numerical aperture of 0.88 NA. The second end 164 of the taper has a numerical aperture of 0.29 NA and an angular aperture of 34 degrees. As a result, the taper 160 provides a number of advantages to the illumination device 150. For example, in the embodiment shown in FIG. 5, the taper 160 collects a very large solid angle of light emitted by the LED 55 because of the high NA at the first end 162 of the taper. At the large surface area end 164, an exit angle of the light from the taper can be provided to substantially match (e.g., substantially similar to) an acceptance angle of the light guide so that a greater amount of light can be transmitted from the LED light source to the light guide. The taper 160 protects the LED 55 from the environment. The taper 160 collimates the light as it passes through the taper 160 and delivers the light in a manner that is more readily coupled to light guides. The taper 160 presents a lower dispersion of light to additional optics should imaging or collection of the light be necessary for a particular application, such as, for example, spot light imaging in a museum or projection of a transparency image. In addition, the taper 160 provides mechanical stability to illumination device 150 and is a rugged element to which additional elements of the illumination device can be easily coupled to.

While the taper 160 as shown in FIG. 5 has its first end 162 in direct contact with the LED 55, other resizing and reshaping arrangements are available. For example, instead of the small surface area end 162 being in contact with the planar light-emitting surface 65 of the LED 55, the larger surface area 164 can be in contact with the light-emitting surface 65. This embodiment allows for a smaller angle of light to be collected from the LED but provides a greater dispersion of light emitted from the taper 160.

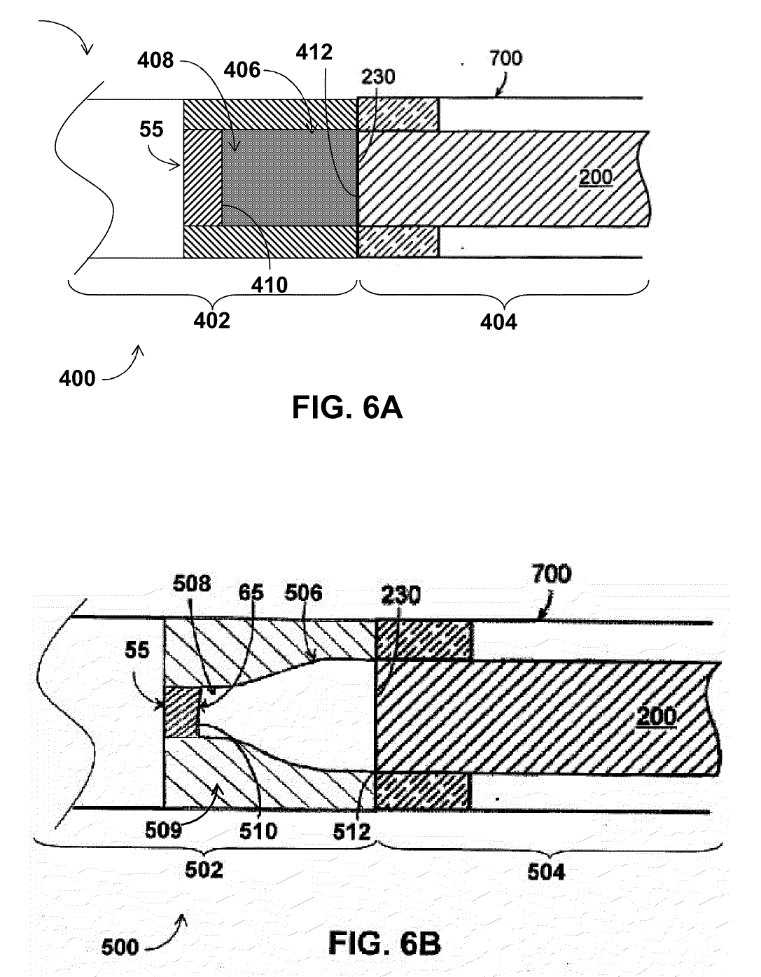

While the taper 160 as shown in FIG. 5 has its first end 162 in direct contact with the LED 55, the first end 162 of the taper 160 can be proximate to the substantially planar light-emitting surface 65, which can be formed of a transparent flat window (e.g., a substantially flat light transmitting plate, a substantially flat light transmitting encapsulant) placed proximate to the LED 55 as shown in FIG. 5A. The LED 55, the substantially planar light-emitting surface 65, and the taper 160 can comprise an illumination device (e.g., illumination device 150 of FIGS. 5 and 6). To illuminate a distant object, the second end 164 of the taper 160 can be connected or positioned proximate to a light receiving end of a light guide (e.g., the light receiving end 215 of the light guide 200 of FIG. 6). The light guide can consist of one or more light transmitting members, such as optical fibers.

In some embodiments, the first end 162 of the taper 160 can be proximate to the light transmitting end of the optical rod 60 as shown in FIG. 5B. The first end 70 of the optical rod 60 is proximate to the substantially planar light-emitting surface 65. The substantially planar light-emitting surface 65 is proximate to LED 55. As shown in FIG. 5B, the substantially planar light-emitting surface 65 can be formed or selected so that a surface area of the light receiving end 162 of the taper 160 substantially approximates the surface area of the LED 55. For example, in some embodiments, as shown in FIGS. 5C and 5D, LED 55 includes a single chip. The surface area of the single chip 55 substantially matches and/or equals the surface area of the light receiving end 162 of the taper 160. In other embodiments, LED 55 includes multiple chips, chip 55A, chip 55B, chip 55C, and chip 55D, combined together as shown in FIG. 5E. The shape and/or size of the light receiving end 162 of taper 160 can be selected to approximate (e.g., substantially match, substantially conform to) the perimeter 59 of the multiple chips. While the single chip 55, the multiple chips 55A-55D, and the light receiving end 162 of the taper 160 are shown in FIGS. 5C-5E to include particular geometric cross-sectional shapes, the chips and the light receiving end 162 of taper 160 can include any geometric cross-sectional shape as described below.

As shown in FIG. 5F, in some embodiments the light guide bundle 80 includes a light transmitting end 100 from which light 102 is transmitted (e.g., to illuminate an object). The light receiving end of the light guide bundle 80 is proximate to the light transmitting end of the optical rod 60. The substantially planar light-emitting surface 65 is positioned between the LED 55 and the first end (light receiving end) of the optical rod 60. The LED 55, the substantially planar light-emitting surface 65, and the optical rod 60 can comprise an illumination device, of which the light emitting end of the optical rod is proximate to the light guide bundle 80.

While shown generally as circular in the Figures, the optical rods or tapers (e.g., optical rod 60 or taper 160) can have different geometric cross-sectional shapes. For example, the optical rod or taper can be a circular or round optical rod or taper, a square optical rod or taper, a hexagonal optical rod or taper, or a optical rod or taper with any other geometric shape. The optical rods or tapers can have different geometric shapes on the light receiving end and light transmitting end. For example, the light receiving end can be square and the light transmitting end can be round, the light receiving end can be round and the light transmitting end can be rectangular (e.g., a high aspect ratio shape), etc. The optical rods or tapers can be hollow (e.g., a round or square optical rod or taper with the interior coated with a reflective material).

Referring to FIG. 6, the illumination device 150 can be combined with a light guide 200 including a light post taper 210. The illumination device 150 can be used as the light source for an endoscope. The light from the LED 55 is emitted through the illumination device 150 and is collected by the light post taper 210, which is adhered to the fiber optic light guide 200. The light guide 200 transmits the light to a remote location, such as, for example, through the body of the endoscope to illuminate an object under inspection. In general, the light post taper 210 selected for use with the illumination device 150 and the light guide 200. The taper 210 has a first end or light receiving end 215 that has a surface area size comparable (e.g., approximate) to the second end (e.g., 164) of the taper 160 and a second end or a light transmitting end 220 that has a surface area size comparable (e.g., approximate) to the size of the connection end 230 of the light guide 200.

FIG. 6A illustrates an illumination system 400 that includes a housing 402 that detachably connects to a light receiving member 404. Light receiving member 404 includes the light guide 200. In other embodiments, the light receiving member 404 can include a combination of one or more light transmitting elements, such as a taper 210 adhered to a light guide fiber bundle 200. That is, the light receiving member in addition to a fiber bundle can further include an optical rod, taper, post. In the embodiment shown in FIG. 6A, the LED 55 together with the optical rod 406 form the illumination device and are disposed within a recess 408 in the housing 402. The LED 55 includes the substantially planar light-emitting surface 410 that is proximate to the optical rod 406 to form a planar interface between LED 55 and rod 406. That is, the substantially planar light-emitting surface 410 and the substantially flat input end of the rod 406 together for the planar interface. In some embodiments, a plate/window (substantially planar light-emitting surface 65) is positioned between the LED 55 and the rod 406 at 410. The optical rod 406 has a substantially planar face 412 that forms a substantially planar interface with light receiving member 404 at the connection end 230.

FIG. 6B illustrates an illumination system 500 that includes a housing 502 that detachably connects to a light receiving member 504. Light receiving member 504 includes the light guide 200. LED 55 together with optical taper 506 form an illumination device, which is disposed within a recess 509 in the housing 502. The LED 55 includes the substantially planar light-emitting surface 510 that is proximate to a light input end 508 of the optical taper 506 to form a planar interface between LED 55 and taper 506. In some embodiments, a substantially planar plate 65 can be positioned between the LED 55 and the taper 506. The optical taper 506 provides a substantially planer surface 512 for connection with the connection end 230 of light receiving member 504.

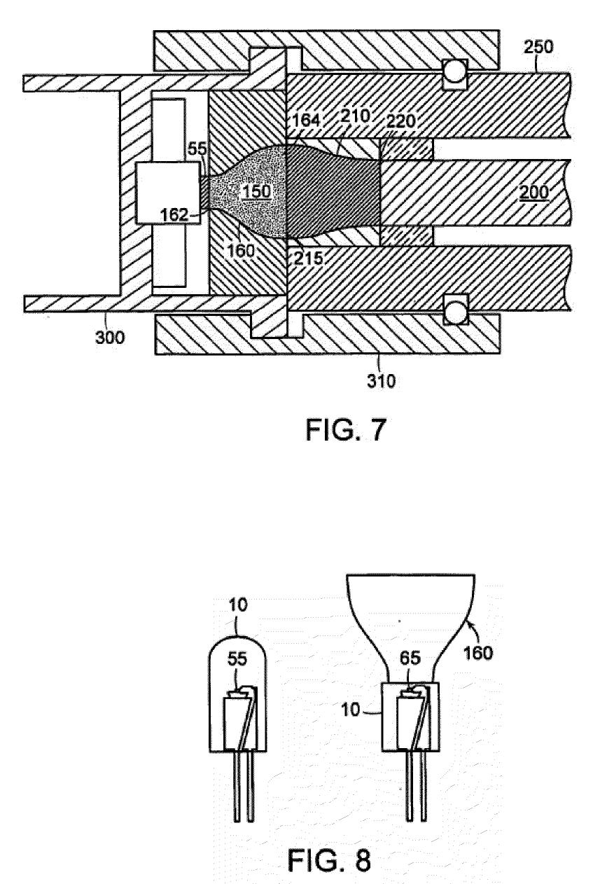

Referring to FIG. 7, illumination device 150 is within a detachable light source housing 300 including a connector 310 to couple the illumination device 150 to a light guide post taper 210 surrounded by a light post 250. The illumination device 150, including the LED 55 having a light-emitting surface 65 proximate to taper 160, is inserted into a recess within the detachable housing 300. In other embodiments, the illumination device can be disposed within a top surface of the detachable housing. In general and as shown in the embodiment of FIG. 7, the light post 250 mates with one end of the detachable housing so that the light post taper 210 comes into direct contact with the taper 160 of the illumination device.

The optical taper 160 and the light post taper 210 can be selected for use with the illumination device 150 to increase the amount of light transmitted from the illumination device into the light guide 200. For example, in an embodiment in which the optical taper 160 has a 1:3 ratio of end areas, with the small surface area end 162 having a 1.0 NA and a large surface area end 164 having a 0.33 NA, the collection angle at the small surface area end 162 is 180 degrees. The 1:3 ratio of end diameters cause the output NA to decrease to 0.33. In other words, the light exiting the larger surface area end 164 has an angular aperture of approximately 39 degrees. As a result, the light initially emitted by the LED 55 over the 180 degrees exits the taper 160 contained in a 39 degree cone at the larger surface area end 164. In the present embodiment, the light post taper 210 located proximate to the larger surface area end 164 is made of 0.66 NA glass and has a 2:1 diameter ratio. As a result, the larger surface area end 215 of the light post taper 210 receives light over about a 39 degree angle, a near perfect match to the light transmitted from the larger surface area end 164 of the optical taper 160. The light entering the light post taper 210 is reduced in diameter by a factor of 2, with a resulting increase in numerical aperture to 0.66 NA and an exit cone angle of 83 degrees for the light exiting the smaller surface area end 220 of the light post taper 210. Adhered directly to the smaller surface area end 220 of the light post taper 210 is the light guide 200 formed of 0.66 NA glass, which has an acceptance angle (e.g., 83 degrees) that substantially matches the exit angle of the light post taper 210 (e.g., 83 degrees).

The illumination devices described above can be used to illuminate objects. For example, by utilizing either device 50 or 150, light from a light source can be collimated and transmitted to illuminate an object. Specifically, by coupling an optical rod or optical taper to a substantially planar light-emitting surface of an LED and activating the LED, the light generated and dispersed by the LED is collimated and transmitted through the optical rod and taper to produce a collimated light beam that can illuminate objects. In certain embodiments, the device 50 or 150 can be disposed within a lamp. When the lamp is positioned relative to an object and the light source 55 within the lamp is activated, the lamp produces a spot light which illuminates the object.

While certain embodiments have been described, other embodiments are also possible. As an example, while LED 55 has been described as a chip 55 free from or removed completely from a dome lens, in some embodiments, such as the embodiment shown in FIG. 8, the LED 55 can remain in a modified or partially removed dome lens. Specifically, the dome lens 10 surrounding the LED 55 can be ground and polished nearly down to the level of the encapsulant-LED interface, so as to preserve the integrity of the mechanical package of the LED chip. After the dome lens has been partially removed, the planar light-emitting surface 65 of the LED 55 is accessible for connection to an end of the optical rod 60 or optical taper 160. To couple the optical rod or taper to the substantially planar light-emitting surface, a manufacturer positions an end of the rod or taper in a proximate relationship to the light-emitting surface 65. This process entails positioning the optical rod or taper as close as possible to the light-emitting surface 65 without damaging the light-emitting qualities of the LED 55. For example, in certain embodiments, the end of the rod or taper is in direct physical contact with the surface 65. In other embodiments, the end of the rod or taper is spaced a distance less than about 1 to 2 millimeters away from the surface 65. As a result, air, gas, adhesive, or an index matching material, such as, for example, a coupling gel may be disposed between the surface 65 and the end of the rod or taper within the 1 to 2 millimeter gap.

In addition, while the light source of the illumination device/system has been described as a LED, other solid state light sources, such as a laser (e.g., a vertical-cavity surface emitting laser) can be utilized herein. Presently preferred embodiments are illustrated in the drawings. Although the figures refer primarily to a single LED that forms the substantially planar light-emitting surface, it should be understood that the subject matter described herein is applicable to multiple light sources (e.g., lasers, LEDs). For example, the light source can be a single package with a plurality of chips, each chip included within a separate package, or multiple chips contained within a single package, that are combined to form the light-emitting surface. Examples of single package multi-chip LEDs include Cree MC-E (Cree, Inc., 4600 silicon Drive, Durham, N.H.) and CBM-360 (Luminus Devices, Inc., 1100 Technology Park Drive, Billerica, Mass.).

Variations, modifications, and other implementations of what is described herein will occur to those of ordinary skill without departing from the spirit and the scope of the invention. Accordingly, the invention is not to be defined only by the preceding illustrative description.

What is claimed is:

1. A detachable illumination system comprising:
a housing that detachably connects to a light receiving member;
an illumination device disposed within a recess in the housing, the illumination device including a substantially planar light-emitting surface; and
an optical rod or taper comprising an input end that is proximate to the substantially planar light-emitting surface and an output end that is proximate to the light receiving member.

2. The system of claim 1, wherein the optical taper provides a light exit angle that substantially matches an acceptance angle of the light receiving member.

3. The system of claim 1, wherein the housing comprises a mechanical connector so that the housing can be detachably connected to the light receiving member.

4. The system of claim 1, wherein the illumination device is a laser.

5. The system of claim 4, wherein the laser is a vertical-cavity surface emitting laser.

6. The system of claim 1, wherein the illumination device is a solid state light source.

7. The system of claim 6, wherein the solid state light source comprises a light-emitting diode.

8. The system of claim 7, wherein the substantially planar light-emitting surface comprises a flat transparent plate disposed above the light-emitting diode.

9. The system of claim 8, wherein the substantially planar light-emitting surface comprises an emitting surface of the light-emitting diode, the system further comprising a substance disposed between the emitting surface and the input end of the optical rod or taper that emits light when the light-emitting diode is activated.

10. The system of claim 9, wherein the substance is at least one of a phosphor or a fluorophor.

11. The system of claim 9, wherein the substance is a solid material comprising at least one of a phosphor or a fluorophor.

12. The system of claim 1, further comprising an adhesive disposed between the substantially planar light-emitting surface and the input end of the optical rod or taper.

13. The system of claim 1, further comprising an index matching material disposed between the substantially planar light-emitting surface and the input end of the optical rod or taper.

14. The system of claim 1, wherein the light receiving member is disposed within an endoscope.

15. The system of claim 1, wherein the housing including the illumination device is disposed within a table top device.

16. The system of claim 1, wherein the optical rod or taper comprises a cross sectional shape that substantially matches a shape defined by a perimeter of the substantially planar light-emitting surface.

17. The system of claim 1, wherein a cross sectional area of the input end of the optical rod or taper substantially approximates a cross sectional area of the substantially planar light-emitting surface.

18. The system of claim 1, wherein the optical rod or taper comprises a round cross section.

19. The system of claim 1, wherein the optical rod or taper comprises a polygonal cross section.

20. The system of claim 19, wherein the polygonal cross section comprises a square cross section or a hexagonal cross section.

21. The system of claim 1, where in the input end of the optical rod or taper comprises a first geometric cross section and the output end of the optical rod or taper comprises a second geometric cross section.

22. The system of claim 21, wherein the first geometric cross section has a shape that differs from the second geometric cross section.

23. The system of claim 22, wherein the first geometric cross section is a square cross section and the second geometric cross section is a round cross section.

24. The system of claim 22, wherein the first geometric cross section is a round cross section and the second geometric cross section is a square cross section.

25. The system of claim 1, further comprising a reflective coating on the outside of the optical rod or taper.

26. The system of claim 25, wherein the reflective coating is an aluminum coating or a silver coating.

27. The system of claim 1, wherein the optical rod or taper is a hollow optical rod or taper.

28. The system of claim 27, wherein the hollow optical rod or taper comprises a reflective coating inside the hollow optical rod or taper.

29. A detachable illumination system comprising:
a housing that detachably connects to a light receiving member comprising an optical rod or taper and a light guide, wherein the optical rod or taper is positioned on the light input end of the light receiving member; and
an illumination device disposed within a recess in the housing, the illumination device including a substantially planar light-emitting surface that is proximate to the light input end of the light receiving member, the illumination device comprising a solid state light source and at least one of an optical rod or taper.

30. A detachable illumination system comprising:
a housing that detachably connects to a light receiving member, the housing comprising an illumination device, the illumination device including a substantially planar light-emitting surface; and
an optical rod or taper comprising an input end that is proximate to the substantially planar light-emitting surface and an output end that is proximate to the light receiving member.

31. A detachable illumination system comprising:
a housing that detachably connects to a light receiving member, the housing comprising an illumination device,
the illumination device comprising a solid state light source having a substantially planar light-emitting surface, and an optical coupling device comprising a substantially flat input end that is proximate to the substantially planar light-emitting surface of the solid state light source and a substantially flat output end that is proximate to the light receiving member.
